(19) United States
(12) Patent Application Publication
(10) Pub. No.: US 2025/0282624 A1
(43) Pub. Date: Sep. 11, 2025

(54) CHEMICAL-FREE PRODUCTION OF GRAPHENE-REINFORCED CEMENT AND CONCRETE

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 18/596,156

(22) Filed: Mar. 5, 2024

(51) Int. Cl. C01B 32/194; C01B 32/192; C01B 32/198

(52) U.S. Cl. CPC C01B 32/194; C01B 32/192; C01B 32/198; C01B 2202/02; C01B 2202/04; C01B 2204/04

(57) ABSTRACT

Provided is a simple, fast, scalable, and environmentally benign method of producing a graphene-enhanced cement or concrete material, the method comprising: (a) mixing multiple particles of a graphitic material and multiple particles of a cement or concrete ingredient to form a mixture in an impacting chamber of an energy impacting apparatus, wherein the impacting chamber optionally contains therein ball-milling media other than the multiple particles of a cement or concrete ingredient; (b) operating the energy impacting apparatus with a frequency and an intensity for a length of time sufficient for peeling off graphene sheets from the particles of graphitic material and transferring the peeled graphene sheets to surfaces of the solid cement or concrete ingredient particles to produce particles of graphene-embraced or graphene-encapsulated cement or concrete ingredient particles inside the impacting chamber; and (c) recovering the graphene-embraced or graphene-encapsulated cement or concrete ingredient particles from the chamber.

### FIELD

The present invention relates to a method of producing graphene-reinforced cement and concrete. The method is environmentally benign, highly scalable, and cost-effective.

### BACKGROUND

Cement-based materials are widely used in infrastructure construction due to their high production efficiency, abundant raw material sources and good workability. As a result, they are the most commonly used construction materials in the world. However, the production of Portland cement can be an activity with high energy consumption and pollution. According to relevant data, the cement industry's carbon dioxide emissions account for approximately 7% of the total global carbon emissions, while energy consumption represents about 2% of the global total. The significant greenhouse gas emissions generated during cement production undeniably affect the environment. In addition, conventional cement-based composite materials exhibit typical brittle material properties due to their poor crack resistance, low tensile strength, and limited strain capacity. These limitations make conventional cement-based materials unable to meet the diverse usage requirements in various engineering fields.

With the rapid development of nanomaterials, researchers have used nanomaterials combined with industrial solid waste materials (e.g., fly ash, waste plastic, reclaimed glass, etc.) to replace a portion of cement in concrete. This approach reduces material costs, reduces carbon emissions and ensures concrete strength, providing a new pathway for producing green and sustainable concrete. In addition, nanomaterials have qualities such as nano-filling, surface effect, and macroscopic quantum tunneling effect, which can improve the overall mechanical and electrical properties and durability of conventional cement-based materials. For example, adding nano silica particles into cement mortar can increase the compressive strength of concrete by about 70%. Likewise, adding 5% alumina nanoparticles resulted in a 43% increase in the elastic modulus of cementitious composites.

Additionally, adding carbon nanotubes can improve the frost resistance of concrete. In recent years, the application of graphene materials in Portland cement has attracted much attention [Zheng, Q.; Han, B.; Cui, X.; Yu, X.; Ou, J. Graphene-Engineered Cementitious Composites: Small Makes a Big Impact. Nanomater. Nanotechnol. 2017, 7, doi: 10.1177/1847980417742304]. Graphene materials can be divided into graphene and graphene derivatives, including graphene oxide (GO), reduced graphene oxide (RGO), graphene nanosheets (GNPs), graphene sulfide, etc. In order to take full advantage of graphene in the field of cement and concreate, one should be able to produce graphene cost-effectively, and without creating any negative impact to the environment.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, hydrogenated graphene, and chemically functionalized graphene.

Graphene materials have been found to have a range of unusual physical, chemical, and mechanical properties. For instance, graphene was found to exhibit the highest intrinsic strength and highest thermal conductivity of all existing materials. Although practical electronic device applications for graphene (e.g., replacing Si as a backbone in a transistor) are not envisioned to occur within the next 5-10 years, its application as a nano filler in a composite material and an electrode material in energy storage devices is imminent. The availability of processable graphene sheets in large quantities is essential to the success in exploiting composite, energy, and other applications for graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101]. Four main prior-art approaches have been followed to produce NGPs. Their advantages and shortcomings are briefly summarized as follows:

### Approach 1: Chemical Formation and Reduction of Graphite Oxide (GO) Platelets

The first approach (FIG. 1) entails treating natural graphite powder with an intercalant and an oxidant (e.g., concentrated sulfuric acid and nitric acid, respectively) to obtain a graphite intercalation compound (GIC) or, actually, graphite oxide (GO). Prior to intercalation or oxidation, graphite has an inter-graphene plane spacing of approximately 0.335 nm (L_{d}=½ d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

There are several major problems associated with this chemical production process:
(1) The process requires the use of large quantities of several undesirable chemicals, such as sulfuric acid, nitric acid, and potassium permanganate or and sodium chlorate.
(2) The chemical treatment process requires a long intercalation and oxidation times, typically 5 hours to five days.
(3) Strong acids consume a significant amount of graphite during this long intercalation/oxidation process by “eating their way into the graphite” (converting graphite into carbon dioxide, which is lost in the process). It is not unusual to lose 20-50% by weight of the graphite material immersed in strong acids and oxidizers.
(4) The thermal exfoliation requires a high temperature (typically 800-1,050° C.) and, hence, is a highly energy-intensive process.
(5) Both heat-and solution-induced exfoliation approaches require a very tedious washing and purification step. For instance, typically 2.5 kg of water is used to wash and recover 1 gram of GIC, producing huge quantities of waste water that need to be properly treated.
(6) In both the heat-and solution-induced exfoliation approaches, the resulting products are GO platelets that should undergo a further chemical reduction treatment to reduce the oxygen content. Typically even after reduction, the electrical conductivity of GO platelets remains much lower than that of pristine graphene. Furthermore, the reduction procedure often involves the utilization of toxic chemicals, such as hydrazine.
(7) Furthermore, the quantity of intercalation solution retained on the flakes after draining may range from 20 to 150 parts of solution by weight per 100 parts by weight of graphite flakes (pph) and more typically about 50 to 120 pph. During the high-temperature exfoliation, the residual intercalate species retained by the flakes decompose to produce various species of sulfuric and nitrous compounds (e.g., NOₓ and SOₓ), which are undesirable. The effluents require expensive remediation procedures in order not to have an adverse environmental impact.

The present invention was made to address these issues. In particular, in some of the embodiments, the invention provides a method and process for producing graphene-enhanced cement and concrete directly without having to produce graphene sheets and then mix the graphene sheets with cement or concrete.

### Approach 2: Direct Formation of Pristine Graphene

In 2002, our research team succeeded in isolating single-layer and multi-layer graphene sheets from partially carbonized or graphitized polymeric carbons, which were obtained from a polymer or pitch precursor [[B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. Mack, et al [“Chemical manufacture of nanostructured materials” U.S. Pat. No. 6,872,330 (Mar. 29, 2005)] developed a process that involved intercalating graphite with potassium melt and contacting the resulting K-intercalated graphite with alcohol, producing violently exfoliated graphite containing NGPs. The process should be carefully conducted in a vacuum or an extremely dry glove box environment since pure alkali metals, such as potassium and sodium, are extremely sensitive to moisture and pose an explosion danger. This process is not amenable to the mass production of NGPs.

### Approach 3: Epitaxial Growth and Chemical Vapor Deposition of Nano Graphene Sheets on Inorganic Crystal Surfaces

Small-scale production of ultra-thin graphene sheets on a substrate can be obtained by thermal decomposition-based epitaxial growth and a laser desorption-ionization technique. Epitaxial films of graphite with only one or a few atomic layers are of technological and scientific significance due to their peculiar characteristics and great potential as a device substrate. However, these processes are not suitable for mass production of isolated graphene sheets for composite materials and energy storage applications.

### Approach 4: The Bottom-Up Approach (Synthesis of Graphene from Small Molecules)

Yang, et al. [“Two-dimensional Graphene Nano-ribbons,” J. Am. Chem. Soc. 130 (2008) 4216-17] synthesized nano graphene sheets with lengths of up to 12 nm using a method that began with Suzuki-Miyaura coupling of 1,4-diiodo-2,3,5,6-tetraphenyl-benzene with 4-bromophenylboronic acid. The resulting hexaphenylbenzene derivative was further derivatized and ring-fused into small graphene sheets. This is a slow process that thus far has produced very small graphene sheets.

Hence, an urgent need exists to have a graphene production process that requires a reduced amount of undesirable chemical, shortened process time, less energy consumption, lower degree of graphene oxidation, reduced or eliminated effluents of undesirable chemical species into the drainage (e.g., sulfuric acid) or into the air (e.g., SO₂ and NO₂). The process should be able to produce more pristine (less oxidized and damaged), more electrically conductive, and larger/wider graphene sheets. The process should be scalable and capable of producing low-cost graphene to enable graphene as a viable reinforcement material for cement and concrete. It is further desirable to have a method and process for directly producing graphene-enhanced cement and concrete without having to first produce graphene sheets which are then mixed with cement or concrete ingredients.

### SUMMARY

The present disclosure provides a strikingly simple, fast, scalable, environmentally benign, and cost-effective method of producing graphene-embraced (graphene-encapsulated) particles of a cement or concrete ingredient. This method meets the aforementioned needs. This method entails producing single-layer or few layer graphene sheets directly from a graphitic or carbonaceous material (a graphene source material) and immediately transferring these isolated (peeled-off) graphene sheets onto surfaces of cement or concrete particles to form graphene-embraced or graphene-encapsulated cement/concrete ingredient particles. In an embodiment, the graphitic material or carbonaceous material has never been previously intercalated, oxidized, or exfoliated and does not include previously produced isolated graphene sheets.

In certain embodiments, the disclosure provides a self-embracing or self-encapsulating method of producing a graphene-embraced or graphene-encapsulated cement/concrete material directly from a graphitic material (without having to produce isolated graphene sheets first from graphite and then mixing graphene sheets with the particles of a cement/concrete ingredient). In some preferred embodiment, the method comprises:
a) mixing multiple particles of a graphitic material and multiple particles of a solid cement/concrete to form a mixture in an impacting chamber of an energy impacting apparatus, wherein the impacting chamber may optionally contain ball-milling media (such as plastic beads, zirconium oxide beads);
b) operating the energy impacting apparatus with a frequency and an intensity for a length of time sufficient for transferring graphene sheets from the particles of graphitic material to surfaces of the solid cement/concrete material particles to produce graphene-embraced cement/concrete ingredient particles inside the impacting chamber (i.e., solid cement/concrete particles impinge upon surfaces of graphitic material particles, peeling off graphene sheets therefrom, and naturally allowing the peeled-off graphene sheets to wrap around or embrace the cement/concrete ingredient particles); and
c) recovering the particles of graphene-embraced cement/concrete ingredient particles from the impacting chamber (this can be as simple as removing the cap to the impacting chamber and removing the particles of graphene-embraced cement/concrete ingredient).

The cement or concrete ingredient may be selected from particles of alumina (Al₂O₃), silica (SiO₂), clinker, lime (CaO), iron, iron oxide, gypsum or calcium sulfate (CaSO₄), limestone (CaCO₃), sand, gravel, clay, crushed stone, blast furnace slag, glass, ground-up concrete, iron oxide (Fe₂O₃), magnesia (MgO), tricalcium silicate (3CaO·SiO₂), dicalcium silicate (2CaO·SiO₂), tricalcium aluminate (3CaO·Al₂O₃), a tetra-calcium alumino-ferrite (4CaO·Al₂O₃Fe₂O₃), or a mixture thereof.

In some embodiments, the cement or concrete ingredient particles have a size from 10 nm to 10 mm (preferably 50 nm to 5 mm, more preferably 100 nm to 1 mm, and further more preferably 500 nm to 500 μm, and most preferably from 1μ to 50 μm).

The method may further include a procedure of mixing the particles of graphene-embraced or graphene-encapsulated cement or concrete ingredients with other cement or concrete ingredients to form a cement or concrete composition. For instance, one may choose to mix the produced graphene-embraced alumina (Al₂O₃) particles with other cement ingredients, such as silica (SiO₂), lime (CaO), iron, gypsum (CaSO₄), and/or limestone (CaCO₃), to form a desired graphene-reinforced cement composition. As another example, one may desire to produce graphene-enhanced concrete by mixing and dispersing graphene-embraced alumina particles, graphene-embraced silica particles, graphene-embraced lime particles, graphene-embraced gypsum particles, and/or graphene-embraced limestone particles in a concrete mixture to form a graphene-enhanced concrete composition. Yet another example is to prepare graphene-embraced concrete ingredient mixture and then add a cement composition to the mixture to produce a graphene-enhanced concrete composition, which can be cured into a strong concrete structure.

It is possible that an amount of residual graphitic material remains after step b), and step c) includes a step of partially or completely separating the residual amount of the graphitic material from the particles of graphene-embraced or graphene-encapsulated cement or concrete ingredient.

The graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, biochar, biochar-derived hard carbon, biochar-derived graphite, or a combination thereof.

The energy impacting apparatus may be a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, rotational or tumbler milling device, or resonant acoustic mixer.

The method tends to lead to the production of graphene that contains single-layer graphene sheets or few-layer graphene sheets, which are deposited on surfaces of cement/concrete ingredient particles or partially or fully embrace or encapsulate these particles. In many cases, the graphene sheets contain at least 80% single-layer graphene or at least 80% few-layer graphene having no greater than 10 graphene planes.

In some embodiments, the procedure of operating the energy impacting apparatus is conducted in a continuous manner using a continuous energy impacting device.

The method may further include a procedure of mixing the particles of graphene-embraced or graphene-encapsulated cement or concrete ingredient particles with desired ingredients of cement or concrete to form a graphene-reinforced cement or concrete member or structure.

Also provided in the present disclosure is a mass of graphene-embraced particles of cement or concrete ingredients produced by the disclosed method, wherein a graphene proportion is from 0.01% to 20% by weight based on the total weight of graphene and the cement or concrete combined.

The disclosure also provides a cement or concrete composition comprising graphene- enhanced cement or concrete material as produced with the presently disclosed method.

The present disclosure further provides a cement or concrete composition that comprises a plurality of graphene-embraced or graphene-encapsulated particles of alumina (Al₂O₃), silica (SiO₂), lime (CaO), iron, gypsum or calcium sulfate (CaSO₄), limestone (CaCO₃), sand, gravel, clay, crushed stone, blast furnace slag, glass, ground-up concrete, iron oxide (Fe₂O₃), magnesia (MgO), tricalcium silicate (3CaO·SiO₂), dicalcium silicate (2CaO·SiO₂), tricalcium aluminate (3CaO·Al₂O₃), a tetra-calcium alumino-ferrite (4CaO·Al₂O₃Fe₂O₃), or a mixture thereof. Although prior art has suggested dispersing graphene sheets in a cement or concrete structure, no prior studies have suggested partially or fully encapsulating or embracing cement and/or concrete ingredients with graphene sheets.

The cement or concrete composition may include chemically functionalized graphene- enhanced cement or concrete material as produced with the disclosed method. The impacting chamber may further contain a functionalizing agent and step (b) of operating the energy impacting apparatus acts to chemically functionalize said graphene sheets with the functionalizing agent. The functionalizing agent may contain a chemical functional group selected from alkyl or aryl silane, alkyl or aralkyl group, hydroxyl group, carboxyl group, amine group, sulfonate group (—SO₃H), aldehydic group, quinoidal, fluorocarbon, or a combination thereof.

In some embodiments, the functionalizing agent contains an oxygenated group selected from the group consisting of hydroxyl, peroxide, ether, keto, and aldehyde. In some embodiments, the functionalizing agent contains a functional group selected from the group consisting of SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

In some embodiments, the functionalizing agent contains a functional group is selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

The functionalizing agent may contain a functional group selected from OY, NHY, O═C—OY, P═C—NR′Y, O═C—SY, O═C—Y, —CR′1—OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—) OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

It may be noted that the graphene production step per se (peeling off graphene sheets directly from graphite particles and immediately or concurrently transferring these graphene sheets to cement/concrete ingredient particle surfaces) is quite surprising, considering the fact that prior researchers and manufacturers have focused on more complex, time intensive and costly methods to create graphene in industrial quantities. In other words, it has been generally believed that chemical intercalation and oxidation is needed to produce bulk quantities of isolated graphene sheets (or NGPs). The present invention defies this expectation in many ways:
1. Unlike the chemical intercalation and oxidation (which requires expansion of inter-graphene spaces, further expansion or exfoliation of graphene planes, and full separation of exfoliated graphene sheets), the instant method directly removes graphene sheets from a source graphitic material and transfers these graphene sheets to surfaces of cement/concrete ingredient particles. No undesirable chemicals (e.g. sulfuric acid and nitric acid) are used.
2. Unlike oxidation and intercalation, pristine graphene sheets can be transferred onto the electrode active material. The sheets being free of oxidation damage allow the creation of graphene-encapsulated particle products with higher electrical and thermal conductivity.
3. Contrary to common production methods, a washing process requiring substantial amounts of water or solvent is not needed
4. Unlike bottom up production methods capable of producing small graphene sheets, large graphene sheets can be produced with the instant method.
5. Unlike CVD and solution-based metalorganic production methods, elevated temperatures are not required to reduce graphene oxide to graphene and metalorganic compounds to pure metal. This greatly reduces the opportunity for undesirable diffusion of carbon into the electrode active material.
6. Unlike CVD and solution-based metalorganic production methods, this process is amenable to almost any electrode active material. The electrode active material does not need to be a compatible “template” or catalyst, as is required for the CVD process.
7. The present invention is amenable to industrial scale production in a continuous energy impact device.

### BRIEF DESCRIPTION OF THE DRAWINGS

FIG. 1 A flow chart showing the most commonly used prior art process of producing highly oxidized graphene sheets (or nano graphene platelets, NGPs) that entails tedious chemical oxidation/intercalation, rinsing, and high-temperature exfoliation procedures.

FIG. 2 A diagram showing the presently invented process for producing graphene-embraced or encapsulated cement or concrete material particles via an energy impacting apparatus according to certain embodiments of the present disclosure.

FIG. 3 A diagram showing the presently invented process for producing graphene-embraced cement or concrete material particles via a continuous ball mill.

FIG. 4 a TEM image of graphene sheets recovered from graphene-embraced solid particles produced by the disclosed method.

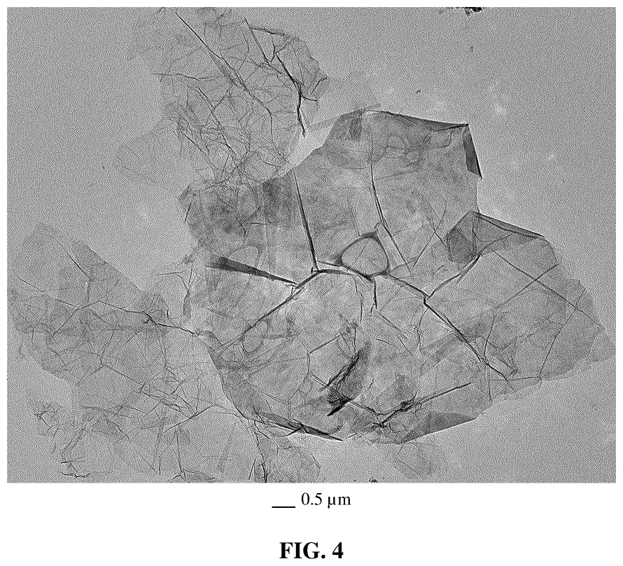

### DETAILED DESCRIPTION

The disclosure provides a method of producing a graphene-embraced or graphene-encapsulated cement/concrete material directly from a graphitic material (without having to produce isolated graphene sheets first from graphite and then mixing graphene sheets with the particles of a cement/concrete ingredient). In some preferred embodiment, the method includes: (a) mixing multiple particles of a graphitic material and multiple particles of a solid cement/concrete to form a mixture in an impacting chamber of an energy impacting apparatus, wherein the impacting chamber may optionally contain ball-milling media (such as plastic beads, zirconium oxide beads); (b) operating the energy impacting apparatus with a frequency and an intensity for a length of time sufficient for transferring graphene sheets from the particles of graphitic material to surfaces of the solid cement/concrete material particles to produce graphene-embraced cement/concrete ingredient particles inside the impacting chamber (i.e., solid cement/concrete particles impinge upon surfaces of graphitic material particles, peeling off graphene sheets therefrom, and naturally allowing the peeled-off graphene sheets to wrap around or embrace the cement/concrete ingredient particles); and (c) recovering the particles of graphene-embraced cement/concrete ingredient particles from the impacting chamber (this can be as simple as removing the cap to the impacting chamber and removing the particles of graphene-embraced cement/concrete ingredient).

The cement or concrete ingredient to be coated or encapsulated with graphene may be selected from particles of alumina (Al₂O₃), silica (SiO₂), lime (CaO), iron, gypsum or calcium sulfate (CaSO₄), clinker, limestone (CaCO₃), sand, gravel, clay, crushed stone, blast furnace slag, glass, ground-up concrete, iron oxide (Fe₂O₃), magnesia (MgO), tricalcium silicate (3CaO·SiO₂), dicalcium silicate (2CaO·SiO₂), tricalcium aluminate (3CaO·Al₂O₃), a tetra-calcium alumino-ferrite (4CaO·Al₂O₃Fe₂O₃), or a mixture thereof.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle. These graphene planes can be separated or isolated from one another to form graphene sheets. The Background section of instant application provides several examples of producing graphene sheets.

One preferred specific embodiment of the present invention is a method of peeling off graphene planes of carbon atoms (1-10 planes of atoms that are single-layer or few-layer graphene sheets) that are directly transferred to surfaces of electrode active material particles. A graphene sheet or nano graphene platelet (NGP) is essentially composed of a sheet of graphene plane or multiple sheets of graphene plane stacked and bonded together (typically, on an average, less than 10 sheets per multi-layer platelet). Each graphene plane, also referred to as a graphene sheet or a hexagonal basal plane, includes a two-dimensional hexagonal structure of carbon atoms. Each platelet has a length and a width parallel to the graphite plane and a thickness orthogonal to the graphite plane. By definition, the thickness of an NGP is 100 nanometers (nm) or smaller, with a single-sheet NGP being as thin as 0.34 nm. However, the NGPs produced with the instant methods are mostly single-layer graphene and some few-layer graphene sheets (<5 layers). The length and width of a NGP are typically between 200 nm and 20 μm, but could be longer or shorter, depending upon the sizes of source graphite material particles.

The present invention provides a strikingly simple, fast, scalable, environmentally benign, and cost-effective process that avoids essentially all of the drawbacks associated with prior art processes of producing graphene sheets and obviates the need to execute a separate (additional) process to combine the produced graphene sheets and particles of a cement/concrete ingredient together to form a composite or hybrid cement/concrete material.

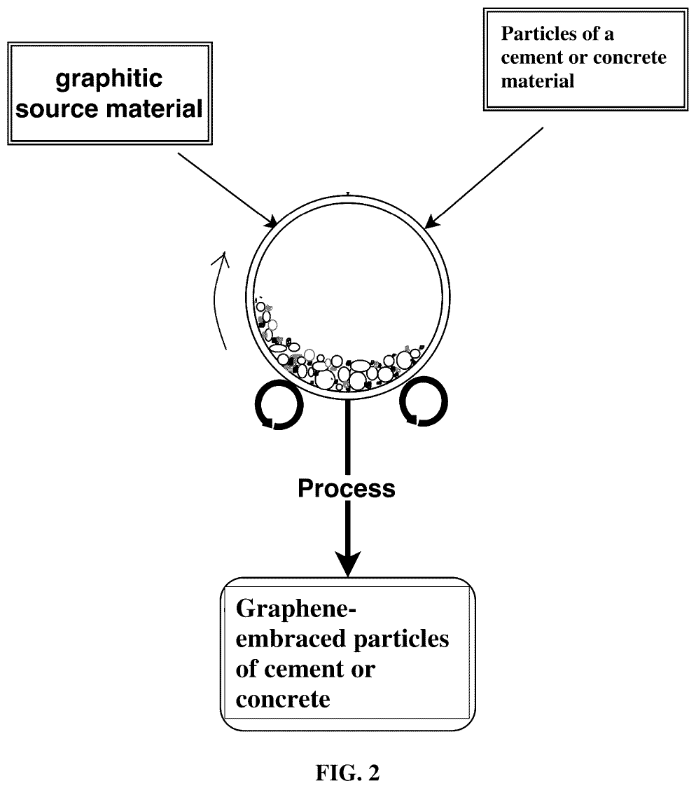

As schematically illustrated in FIG. 2, one preferred embodiment of this method entails placing particles of a source graphitic material and particles of a solid cement or concrete material (if without any externally added impacting balls, such as ball-milling media) in an impacting chamber. After loading, the resulting mixture is exposed to impacting energy, which is accomplished, for instance, by rotating the chamber to enable the impacting of the active material particles against graphite particles. These repeated impacting events (occurring in high frequencies and high intensity) act to peel off graphene sheets from the surfaces of graphitic material particles and, immediately and directly, transfer these graphene sheets to the surfaces of the cement/concrete material particles to form graphene-embraced cement/concrete material particles. Typically, the entire particle is covered by graphene sheets (fully wrapped around, embraced or encapsulated). This is herein referred to as the “direct transfer” process.

Alternatively but less desirably, impacting balls (e.g. stainless steel or zirconia beads) may be added into the impacting chambers and, as such, graphene sheets may also be peeled off by the impacting balls and tentatively transferred to the surfaces of these impacting balls first. When the graphene-coated impacting balls subsequently impinge upon the cement/concrete material particles, the graphene sheets are transferred to surfaces of the cement/concrete material particles to form graphene-coated particles. This is an “indirect transfer” process. A drawback of such an indirect transfer process is the need to separate the externally added impacting balls (e.g. ball-milling media) from the graphene-embraced particles.

In less than two hours (often less than 1 hour) of operating the direct transfer process, most of the constituent graphene sheets of source graphite particles are peeled off, forming mostly single-layer graphene and few-layer graphene (mostly less than 5 layers or 5 graphene planes). Following the direct transfer process (graphene sheets wrapped around cement/concrete ingredient particles), the residual graphite particles (if present) are separated from the graphene-embraced (graphene-encapsulated) particles using a broad array of methods. Separation or classification of graphene-embraced (graphene-encapsulated) particles from residual graphite particles (if any) can be readily accomplished based on their differences in weight or density, particle sizes, magnetic properties, etc. The resulting graphene-embraced particles are already a two-component material; i.e. they are already “mixed” and there is no need to have a separate process of mixing isolated graphene sheets with these cement/concrete material particles. Of course, one may desire to further mix these graphene-enhanced particles with additional cement/concrete ingredients.

In other words, production of graphene sheets and mixing of graphene sheets with a cement or concrete material are essentially accomplished concurrently in one operation. This is in stark contrast to the traditional processes of producing graphene sheets first and then subsequently mixing the graphene sheets with a cement/concrete material. It is more challenging to use traditional dry mixing to produce homogeneous mixtures of two or multiple solid components.

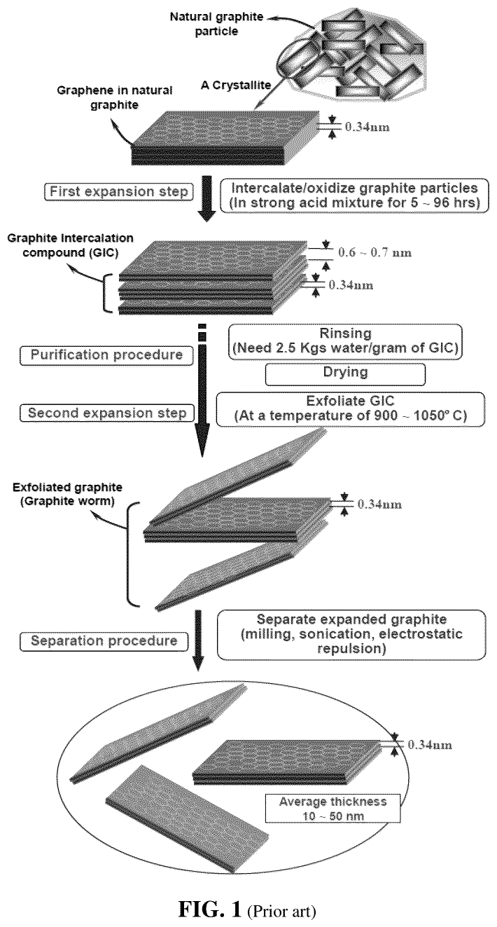

As shown in FIG. 1, the prior art chemical processes for producing graphene sheets or platelets alone typically involve immersing graphite powder in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water and then subjected to drying treatments to remove water. The dried powder, referred to as graphite intercalation compound (GIC) or graphite oxide (GO), is then subjected to a thermal shock treatment. This can be accomplished by placing GIC in a furnace pre-set at a temperature of typically 800-1100° C. (more typically 950-1050° C.). The resulting products are typically highly oxidized graphene (i.e. graphene oxide with a high oxygen content), which should be chemically or thermal reduced to obtain reduced graphene oxide (RGO). RGO is found to contain a high defect population and, hence, is not as conducting as pristine graphene. We have observed that that the pristine graphene paper (prepared by vacuum-assisted filtration of pristine graphene sheets, as herein prepared) exhibit electrical conductivity values in the range of 1,500-4,500 S/cm. In contrast, the RGO paper prepared by the same paper-making procedure typically exhibits electrical conductivity values in the range of 100-1,000 S/cm.

In the most common implementation of ball mill mixing, previously produced graphene sheets or platelets are added to solid material powders. Impact energy is applied via ball mill for a period of time to disperse graphene platelets or sheets in the powder. This is often carried out in a liquid (solvent) solution. The disadvantages of this mixing process are obvious—graphene is a costly input material, solvent recovery is required, and most significantly, the graphene input into the process has been damaged by oxidation during prior processing. This reduces desirable end properties, such as thermal conductivity and electrical conductivity.

Another prior art process is coating of CVD onto metal nano particles. This is the most limited of all prior art methods, being possible only on certain metals that are suitable catalysts for facilitating decomposition of hydrocarbon gas to form carbon atoms and as templates for graphene to grow on. As a “bottom up” graphene production method, it requires costly capital equipment and costly input materials.

In all the prior art processes for producing graphene-enhanced cement/concrete particles, isolated graphene sheets are produced using a known method. These graphene sheets and all the necessary ingredients of a cement/concrete material are then mixed using a dry mixing method or dispersed in a liquid solvent (e.g. water) to form a slurry to effect mixing. Graphene sheets, being a nano material, are difficult to disperse and have a high tendency to cluster together. Non-uniform mixing can lead to a cement or concrete structure exhibiting unsatisfactory performance characteristics.

In contrast, the presently invented impacting process entails combining graphene production, functionalization (if desired), and mixing of graphene with cement/concrete ingredients in a single operation. This fast and environmentally benign process not only avoids significant chemical usage, but also produces embracing graphene sheets of higher quality—pristine graphene as opposed to thermally reduced graphene oxide produced by the prior art process. Pristine graphene enables the creation of embraced particles with higher electrical and thermal conductivity. Graphene-coated particles are already a mixture of two materials; uniform mixing is naturally accomplished.

Although the mechanisms remain incompletely understood, this revolutionary process of the present invention has essentially eliminated the conventionally required functions of graphene plane expansion, intercalant penetration, exfoliation, and separation of graphene sheets and replace it with a single, entirely mechanical exfoliation process. The whole process can take less than 2 hours (typically 10 minutes to 1 hour), and can be done with no added chemicals. This is absolutely stunning, a shocking surprise to even those top scientists and engineers or those of extraordinary ability in the art.

Another surprising result of the present study is the observation that a wide variety of carbonaceous and graphitic materials can be directly processed without any particle size reduction or pre-treatment. The particle size of graphite can be smaller than, comparable to, or larger than the particle size of the cement/concrete material. The graphitic material may be selected from natural graphite, synthetic graphite, highly oriented pyrolytic graphite, meso-carbon micro-bead, graphite fiber, graphitic nano-fiber, graphite oxide, graphite fluoride, chemically modified graphite, exfoliated graphite, or a combination thereof. It may be noted that the graphitic material used for the prior art chemical production and reduction of graphene oxide requires size reduction to 75 um or less in average particle size (typically less than 25 um). This process requires size reduction equipment (for example hammer mills or screening mills), energy input, and dust mitigation. By contrast, the energy impacting device method can accept almost any size of graphitic material. A starting graphitic material of several mm or cm in size or larger or a starting material as small as nano-scaled has been successfully processed to create graphene-coated or graphene-embedded particles of cement/concrete materials. The only size limitation is the chamber capacity of the energy impacting device; but this chamber can be very large (industry-scaled).

The presently invented process is capable of producing single-layer graphene sheets that completely wrap around the particles of a cement/concrete material. In many examples, the graphene sheets produced contain at least 80% single-layer graphene sheets. The graphene produced can contain pristine graphene, oxidized graphene with less than 5% oxygen content by weight, graphene fluoride, graphene oxide with less than 5% fluorine by weight, graphene with a carbon content of no less than 95% by weight, or functionalized graphene.

The presently invented process does not involve the production of GIC and, hence, does not require the exfoliation of GIC at a high exfoliation temperature (e.g. 800-1,100° C.). This is another major advantage from environmental protection perspective. The prior art processes require the preparation of dried GICs containing sulfuric acid and nitric acid intentionally implemented in the inter-graphene spaces and, hence, necessarily involve the decomposition of H₂SO₄ and HNO₃ to produce volatile gases (e.g. NOₓ and SOₓ) that are highly regulated environmental hazards. The presently invented process completely obviates the need to decompose H₂SO₄ and HNO₃ and, hence, is environmentally benign. No undesirable gases are released into the atmosphere during the combined graphite expansion/exfoliation/separation process of the present invention.

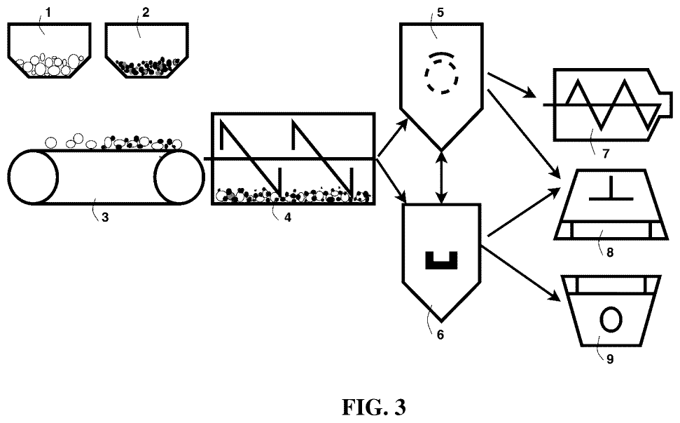

In a desired embodiment, the presently invented method is carried out in an automated and/or continuous manner. For instance, as illustrated in FIG. 3, the mixture of graphite particles 1 and cement/concrete material particles 2 is delivered by a conveyer belt 3 and fed into a continuous ball mill 4. After ball milling to form graphene-embraced particles, the product mixture (possibly also containing some residual graphite particles) is discharged from the ball mill apparatus 4 into a screening device (e.g. a rotary drum 5) to separate graphene-embraced particles from residual graphite particles (if any). This separation operation may be assisted by a magnetic separator 6 if the cement/concrete material is ferromagnetic (e.g. containing Fe, Co, Ni, or Mn-based metal in some desired electronic configuration). The graphene-embraced particles may be delivered into a powder classifier, a cyclone, and or an electrostatic separator. The particles may be further processed, if so desired, by melting 7, pressing 8, or grinding/pelletizing apparatus 9. These procedures can be fully automated. The process may include characterization or classification of the output material and recycling of insufficiently processed material into the continuous energy impacting device. The process may include weight monitoring of the load in the continuous energy impacting device to optimize material properties and throughput.

In some embodiments, the cement/concrete material particles include powder, flakes, beads, pellets, spheres, wires, fibers, filaments, discs, ribbons, or rods, having a diameter or thickness preferably from 10 nm to 20 mm. Preferably, the diameter or thickness is from 1 μm to 100 μm.

In the invented method, the graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

The energy impacting apparatus may be a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer. The procedure of operating the energy impacting apparatus may be conducted in a continuous manner using a continuous energy impacting device

Graphene sheets transferred to cement/concrete material surfaces have a significant proportion of surfaces that correspond to the edge planes of graphite crystals. The carbon atoms at the edge planes are reactive and should contain some heteroatom or group to satisfy carbon valency. There are many types of functional groups (e.g. hydroxyl and carboxylic) that are naturally present at the edge or surface of graphene nano platelets produced through transfer to a solid carrier particle. The impact-induced kinetic energy is of sufficient energy and intensity to chemically activate the edges and even surfaces of graphene sheets embraced around active material particles (e.g. creating highly active sites or free radicals). Provided that certain chemical species containing desired chemical function groups (e.g. OH—, —COOH, —NH₂, Br—, etc.) are included in the impacting chamber, these functional groups can be imparted to graphene edges and/or surfaces. In other words, production and chemical functionalization of graphene sheets can be accomplished concurrently by including appropriate chemical compounds in the impacting chamber. In summary, a major advantage of the present invention over other processes is the simplicity of simultaneous production and modification of graphene surface chemistry for improved battery performance.

Graphene platelets derived by this process may be functionalized through the inclusion of various chemical species in the impacting chamber. In each group of chemical species discussed below, we selected 2 or 3 chemical species for functionalization studies.

In one preferred group of chemical agents, the resulting functionalized NGP may broadly have the following formula(e): [NGP]—Rₘ, wherein m is the number of different functional group types (typically between 1 and 5), R is selected from SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate.

Graphene-embraced cement/concrete material particles may be used to improve the mechanical properties, electrical conductivity and thermal conductivity of a cement or concrete structure.

Other useful chemical functional groups or reactive molecules may be selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), hexamethylenetetramine, polyethylene polyamine, polyamine epoxy adduct, phenolic hardener, non-brominated curing agent, non-amine curatives, and combinations thereof. These functional groups are multi-functional, with the capability of reacting with at least two chemical species from at least two ends. Most importantly, they are capable of bonding to the edge or surface of graphene using one of their ends and, during subsequent epoxy curing stage, are able to react with epoxide or epoxy resin material at one or two other ends.

The above-described [NGP]—Rₘ may be further functionalized. This can be conducted by opening up the lid of an impacting chamber after the —Rₘ groups have been attached to graphene sheets and then adding the new functionalizing agents to the impacting chamber and resuming the impacting operation. The resulting graphene sheets or platelets include compositions of the formula: [NGP]—Aₘ, where A is selected from OY, NHY, O═C—OY, P═C—NR′Y, O═C—SY, O═C—Y, —CR′1—OY, N′Y or C′Y, and Y is an appropriate functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

The NGPs may also be functionalized to produce compositions having the formula:

[NGP]—[R′—A]ₘ, where m, R′ and A are as defined above. The compositions of the invention also include NGPs upon which certain cyclic compounds are adsorbed. These include compositions of matter of the formula: [NGP]—[X—Rₐ]ₘ, where a is zero or a number less than 10, X is a polynuclear aromatic, polyheteronuclear aromatic or metallopolyheteronuclear aromatic moiety and R is as defined above. Preferred cyclic compounds are planar. More preferred cyclic compounds for adsorption are porphyrins and phthalocyanines. The adsorbed cyclic compounds may be functionalized. Such compositions include compounds of the formula, [NGP]—[X—Aₐ]ₘ, where m, a, X and A are as defined above.

The functionalized NGPs of the instant invention can be prepared by sulfonation, electrophilic addition to deoxygenated platelet surfaces, or metallation. The graphitic platelets can be processed prior to being contacted with a functionalizing agent. Such processing may include dispersing the platelets in a solvent. In some instances the platelets may then be filtered and dried prior to contact. One particularly useful type of functional group is the carboxylic acid moieties, which naturally exist on the surfaces of NGPs if they are prepared from the acid intercalation route discussed earlier. If carboxylic acid functionalization is needed, the NGPs may be subjected to chlorate, nitric acid, or ammonium persulfate oxidation.

Carboxylic acid functionalized graphitic platelets are particularly useful because they can serve as the starting point for preparing other types of functionalized NGPs. For example, alcohols or amides can be easily linked to the acid to give stable esters or amides. If the alcohol or amine is part of a di- or poly-functional molecule, then linkage through the O- or NH-leaves the other functionalities as pendant groups. These reactions can be carried out using any of the methods developed for esterifying or aminating carboxylic acids with alcohols or amines as known in the art. Examples of these methods can be found in G. W. Anderson, et al., J. Amer. Chem. Soc. 96, 1839 (1965), which is hereby incorporated by reference in its entirety. Amino groups can be introduced directly onto graphitic platelets by treating the platelets with nitric acid and sulfuric acid to obtain nitrated platelets, then chemically reducing the nitrated form with a reducing agent, such as sodium dithionite, to obtain amino-functionalized platelets. Functionalization of the graphene-coated inorganic particles may be used as a method to introduce dopants into the cement/concrete material.

The following examples serve to provide the best modes of practice for the present invention and should not be construed as limiting the scope of the invention:

### Example 1: Graphene Embraced Particles of Cement Ingredients

The cement typically contains 35 to 40 percent lime, 40 to 50 percent alumina, up to 15 percent iron oxides, and typically about 5 percent silica. After mixing and heat-treating, the major compounds that make up Portland cement are tricalcium silicate (3 CaO·SiO₂), dicalcium silicate (2 CaO·SiO₂), tricalcium aluminate (3 CaO·Al₂O₃), and tetracalcium aluminoferrite (4 CaO·Al₂O₃·Fe₂O₃); gypsum is then added into this mixture.

Several types of cement materials in a fine powder form were investigated. These include alumina (Al₂O₃), silica (SiO₂), lime (CaO), iron oxide particles, and size-reduced clinker (basically a mixture of tricalcium silicate, dicalcium silicate, tricalcium aluminate, and tetracalcium aluminoferrite). These are used as examples to illustrate the best mode of practice. These cement ingredient particles either were prepared in house or were commercially available. One type or multiple types of fine powders could be mixed with graphite particles in an impacting chamber.

In an experiment, 1 kg of cement material powder and 100 grams of natural flake graphite, 50 mesh (average particle size 0.18 mm; Asbury Carbons, Asbury NJ) were placed in a high-energy ball mill container. The ball mill was operated at 300 rpm for 0.5 to 4 hours. The container lid was then removed and particles of the active materials were found to be fully coated (embraced or encapsulated) with a dark layer, which was verified to be graphene by Raman spectroscopy. The mass of processed material was placed over a 50 mesh sieve and, in some cases, a small amount of unprocessed flake graphite was removed.

### Example 2: Graphene-Embraced Sand Particles (a Concrete Ingredient)

In an experiment, 20 grams of fine sand powder (21-105 μm in diameter) and 2.5 grams highly oriented pyrolytic graphite (HOPG) were placed in a resonant acoustic mill and processed for 5 minutes. For comparison, the same experiment was conducted, but the milling container further contains zirconia milling beads. We were surprised to discover that the former process (fine sand particles serving as the milling media per se without the externally added zirconia milling beads) led to mostly single-particle particulate (each particulate containing one particle encapsulated by graphene sheets). In contrast, with the presence of externally added milling beads, a graphene-embraced particulate tends to contain multiple sand particles (typically 3-6) wrapped around by graphene sheets.

### Example 3: Graphene-Encapsulated Fine Particles of Crushed Stone (a Concrete Ingredient)

In a first experiment, 500 g of crushed stone powder (particle diameter ˜3 mm) and 50 grams of highly oriented pyrolytic graphite (HOPG) were placed in a high-intensity ball mill. The mill was operated for 20 minutes, after which the container lid was opened and un-processed HOPG was removed by a 50 mesh sieve. The crushed stone particles were coated with a dark layer, which was verified to be graphene by Raman spectroscopy.

### Example 4: Graphene-Embraced Fine Clay Particles (Using Meso-Carbon Micro Beads or MCMBs as the Graphene Source)

In one example, 500 grams of clay powder (0.3-0.5 mm in diameter), as a concrete ingredient, and 10 grams of MCMBs (China Steel Chemical Co., Taiwan) were placed in a ball mill, and processed for 3 hours. In separate experiments, un-processed MCMB was removed by sieving, air classification, and settling in a solvent solution. The graphene loading of the coated particles was estimated to be 0.45 weight %.

Graphene-embraced clay particles were then mixed with other concrete ingredients (fine sand particles, fine particles of crushed stone, etc.) and cement (with or without graphene-embraced cement ingredients mixed therein) to form a concrete composition. The concrete composition was then mixed with water to form concrete slabs. Both standard compressive and flexural testing procedures were conducted to measure mechanical properties of graphene-reinforced concrete and unreinforced counterparts. It was observed that, with a graphene content of 0.025%-0.45% by weight, the compressive strength of concrete could be increased by 3%-14% while the flexural strength increased by 14%-26%.

### Example 5: Graphene Encapsulation of Fine Clinker Particles via Direct Transfer vs. Chemical Production of Graphene Sheets Plus Freezer Milling

A sample of graphene-embraced fine clinker particles was prepared via the presently invented direct transfer method (using fine clinker particles themselves as the milling media and natural graphite as the graphene source).

In a separate experiment, 10 grams of fine clinker powder and 1 gram of reduced graphene oxide sheets (produced with the Hummer's method explained below) were placed in a freezer mill (Spex Mill, Spex Sample Prep, Metuchen NJ) and processed for 10 minutes. In this experiment, graphite oxide as prepared by oxidation of graphite flakes with sulfuric acid, nitrate, and permanganate according to the method of Hummers [U.S. Pat. No. 2,798,878, Jul. 9, 1957]. Upon completion of the reaction, the mixture was poured into deionized water and filtered. The graphite oxide was repeatedly washed in a 5% solution of HCl to remove the majority of the sulphate ions. The sample was then washed repeatedly with deionized water until the pH of the filtrate was neutral. The slurry was spray-dried and placed in a vacuum oven at 60° C. for 24 hours. The interlayer spacing of the resulting laminar graphite oxide was determined by the Debey-Scherrer X-ray technique to be approximately 0.73 nm (7.3 A). A sample of this material was subsequently transferred to a furnace pre-set at 650° C. for 4 minutes for exfoliation and heated in an inert atmosphere furnace at 1200° C. for 4 hours to create a low density powder including few layer reduced graphene oxide (RGO). Surface area was measured via nitrogen adsorption BET.

As discussed in the Background section, there are seven (7) major problems associated with the chemical method of graphene production. In addition, the graphene sheets, once produced, tend to result in non-uniform dispersion in a concrete structure. In contrast, the presently disclosed method leads to visibly better dispersion of graphene in the concrete.

1. A method of producing a graphene-enhanced cement or concrete material, said method comprising:
a) mixing multiple particles of a graphitic material and multiple particles of a cement or concrete ingredient to form a mixture and placing said mixture in an impacting chamber of an energy impacting apparatus;
b) operating said energy impacting apparatus with a frequency and an intensity for a length of time sufficient for peeling off graphene sheets from said particles of graphitic material and transferring said peeled graphene sheets to surfaces of said cement or concrete ingredient particles to produce particles of graphene-embraced or graphene-encapsulated cement or concrete ingredient inside said impacting chamber; and
c) recovering said particles of graphene-embraced or graphene-encapsulated cement or concrete ingredient from said impacting chamber.

2. The method of claim 1, wherein said cement or concrete ingredient includes particles of alumina (Al₂O₃), silica (SiO₂), lime (CaO), iron, gypsum or calcium sulfate (CaSO₄), clinker, limestone (CaCO₃), sand, gravel, clay, crushed stone, blast furnace slag, glass, ground-up concrete, iron oxide (Fe₂O₃), magnesia (MgO), tricalcium silicate (3CaO·SiO₂), dicalcium silicate (2CaO·SiO₂), tricalcium aluminate (3CaO·Al₂O₃), a tetra-calcium alumino-ferrite (4CaO·Al₂O₃Fe₂O₃), or a mixture thereof.

3. The method of claim 1, wherein said cement or concrete ingredient particles have a size from 10 nm to 10 mm.

4. The method of claim 1, wherein the method further includes mixing said particles of graphene-embraced or graphene-encapsulated cement or concrete ingredient with additional cement or concrete ingredients to form a cement or concrete composition.

5. The method of claim 1, wherein said graphitic material is selected from natural graphite, synthetic graphite, highly oriented pyrolytic graphite, graphite fiber, graphitic nano-fiber, graphite fluoride, chemically modified graphite, meso-carbon micro-bead, partially crystalline graphite, biochar, biochar-derived hard carbon, biochar-derived graphite, or a combination thereof.

6. The method of claim 1, wherein the energy impacting apparatus is a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, a rotational or tumbler milling device, or resonant acoustic mixer.

7. The method of claim 1 wherein said graphene sheets contain single-layer graphene sheets.

8. The method of claim 1 wherein said graphene sheets contain at least 80% single-layer graphene or at least 80% few-layer graphene having no greater than 10 graphene planes.

9. The method of claim 1, wherein said procedure of operating said energy impacting apparatus is conducted in a continuous manner using a continuous energy impacting device.

10. The method of claim 1, wherein said method further includes a procedure of mixing said particles of graphene-embraced or graphene-encapsulated cement or concrete ingredient particles with desired ingredients of cement or concrete to form a graphene-reinforced cement or concrete member or structure.

11. The method of claim 1, wherein said impacting chamber may further contain a functionalizing agent and step (b) of operating the energy impacting apparatus acts to chemically functionalize said graphene sheets with said functionalizing agent.

12. A mass of graphene-embraced particles of a cement or concrete ingredient produced by the method of claim 1, wherein a graphene proportion is from 0.01% to 20% by weight based on the total weight of graphene and the cement or concrete combined.

13. A cement or concrete composition comprising a graphene-enhanced cement or concrete material as produced with the method of claim 1.

14. A cement or concrete composition comprising chemically functionalized graphene-enhanced cement or concrete material as produced with the method of claim 1.

15. A cement or concrete composition comprising a plurality of graphene-embraced or graphene-encapsulated particles of alumina (Al₂O₃), silica (SiO₂), lime (CaO), iron, gypsum or calcium sulfate (CaSO₄), limestone (CaCO₃), sand, gravel, clay, crushed stone, blast furnace slag, glass, ground-up concrete, iron oxide (Fe₂O₃), magnesia (MgO), tricalcium silicate (3CaO·SiO₂), dicalcium silicate (2CaO·SiO₂), tricalcium aluminate (3CaO·Al₂O₃), a tetra-calcium alumino-ferrite (4CaO·Al₂O₃Fe₂O₃), or a mixture thereof.

16. The method of claim 1, wherein said impacting chamber contains therein ball-milling media other than said multiple particles of a cement or concrete ingredient.
